(19) United States
(12) Patent Application Publication
(10) Pub. No.: US 2014/0192132 A1
(43) Pub. Date: Jul. 10, 2014

(54) AUTOMATED SCHEDULING OF INMATE VISITS

(71) Applicants: Robert Clayton Avery, Decatur, AL (US); Thomas Edward Viloria, Reno, NV (US)

(72) Inventors: Robert Clayton Avery, Decatur, AL (US); Thomas Edward Viloria, Reno, NV (US)

(73) Assignee: iWebVisit.com, LLC, Decatur, AL (US)

(21) Appl. No.: 13/538,856

(22) Filed: Jun. 29, 2012

Related U.S. Application Data
(60) Provisional application No. 61/503,222, filed on Jun. 30, 2011.

(51) Int. Cl. G06Q 10/00; G06Q 10/06

(52) U.S. Cl. 348/14.01; 705/7.19

(57) ABSTRACT

Processes, systems, and devices for the automated scheduling of visits with persons having limited access to communications or limited ability to travel are provided. This involves the receipt of a machine-readable visit request. The visit request is used to schedule either a videoconference or a contact visit using a scheduling database. Systems for the automated arrangement of confidential visits (both in person and via videoconference) and systems for dynamically revising scheduled visits in response to updates from a jail management system are also provided.

### CROSS-REFERENCE TO RELATED APPLICATIONS

This application cites the benefit under 35 U.S.C. §119(e) of U.S. Provisional Patent Application 61/503,222, filed on Jun. 30, 2011 (currently pending), and which is incorporated herein by reference in its entirety.

### BACKGROUND

A. Field of the Disclosure

The present disclosure relates generally to automated data processing and communication; more specifically the disclosure relates to applications of automated data processing and communication in confined-access settings.

B. Background

In many situations, a person is inaccessible for communications with his friends, family, and other associates. Although written correspondence is virtually always available in the form of the post or electronic mail, these forms of communication are severely limited in their ability to maintain a dialog. Furthermore, the fine points of meaning and emotion that are conveyed by facial expressions cannot be communicated in writing. Consequently, there is no substitute for mutual visual communications.

Visual communications are achieved in two ways: through face-to-face (contact) meetings and through videoconferences. The person in question (the “visitee”) may be separated from potential visitors by great distance, making contact visits impractical. The visitee may have very limited access to telecommunications, requiring careful scheduling of resources.

If a visitee is being frequently relocated, this complicates the scheduling of visits. Contact visits, which require travel, must be scheduled ahead of time. Videoconference visits must also be scheduled ahead of time if telecommunications resources are limited. Prisoners, military personnel, hospital patients, and some private employees have highly regimented schedules (or highly chaotic schedules) which only allow for visits at certain times under certain conditions.

In the penal setting, the need to strictly regulate visits is of increased importance. Contact visits create opportunities for contraband to enter the penal system. Contact visits may also be difficult to adequately monitor. Visitors often cannot afford to spend the time and money required to travel to the penal institution. For at least these reasons, penal institutions prefer videoconference visits to contact visits.

Videoconferencing in the penal environment presents its own difficulties. Penal institutions cannot forbid contact visits altogether, especially when the visitor is an attorney, doctor, or other professional who must see the inmate personally. This introduces the complication of requiring the penal facility to maintain a system for scheduling videoconferences and a system for scheduling contact visits. Videoconferencing equipment and software is expensive to acquire and maintain, and penal facilities in the United States face constantly shrinking budgets and rising inmate populations. Videoconferencing also introduces the complication of attempting to authenticate the identity of a visitor without the visitor's presence.

Consequently, there is a long-felt but unmet need in the art for an improved process for scheduling visits to such visitees.

### SUMMARY

The following presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

The needs described above are addressed by various embodiments of the devices, processes, and systems disclosed herein, although it is to be understood that not every embodiment will address each such need. These embodiments variously solve the problems in the art by tracking the whereabouts of inmates and dynamically adjusting visits to adapt to changing whereabouts, integrating videoconference scheduling and contact visit scheduling, integrating general visit scheduling with confidential visit scheduling, and integrating videoconference scheduling with videoconference room scheduling.

Processes for arranging inmate visits are provided. The processes generally comprise receiving a visit request in machine-readable format, said request identifying an inmate residing in the facility; reading from a scheduling database available times for a visitation venue; and designating the venue as booked in the database at the visit times.

A general embodiment of the process pertaining to confidential visits comprises receiving a visit request in machine-readable format, said request identifying an inmate residing in the facility; reading a database record associated with the visitor from a visitor database, said record comprising a confidant variable designating that the visitor is entitled to confidential visits; reading from a scheduling database available times for a venue; receiving a selection of a visit time in machine-readable format that coincides with an available time; designating the venue as booked at the visit time in the scheduling database; and, if the venue is a videoconference terminal, designating the room in the facility in which the inmate terminal is located as private to the inmate at the visit time in the scheduling database.

Another general embodiment pertaining to a videoconference visit comprises: receiving a visit request in machine-readable format identifying an inmate residing in the facility; reading from a scheduling database available times for a videoconference terminal; receiving a selection of a visit time in machine-readable format that coincides with one or more available times; designating the terminal as booked at the visit time in the scheduling database; receiving an update of the inmate's location in machine-readable format from a jail management system indicating that the inmate has been moved to a new location or that the inmate has been released; if the inmate has been released, transmitting a cancellation to the visitor via a telecommunications network; if the inmate has been moved to a new location, searching for an available videoconference terminal at the new location at the visit time in a scheduling database for the new location, wherein if an available terminal is found, designating the terminal at the new location as booked at the visit time in the scheduling database for the new location, or if an available terminal is not found, transmitting a cancellation to the visitor via a telecommunications network.

Yet another general embodiment of the process pertaining to a local visit comprises: receiving a local visit request in machine-readable format identifying an inmate residing in the facility; reading from a scheduling database available times for a venue; assigning a visit time that coincides with an available time; designating the venue as booked at the visit time in the scheduling database; receiving an update of the inmate's location in machine-readable format from a jail management system, indicating that the inmate has been moved to a new location or that the inmate has been released; if the inmate has been released, transmitting a cancellation to the visitor via a telecommunications network; if the inmate has been moved to a new location, searching a scheduling database for a new venue selected from the group consisting of a videoconference terminal at the new location that is available at the visit time, and a contact room at the new location that is available at the visit time, if an available new venue is found, designating said new venue as booked in the scheduling database for the new location at the visit time, or if an available venue is not found, transmitting a cancellation to the visitor via a telecommunications network.

Yet another general embodiment of the process pertains to a contact visit comprising: receiving a contact visit request in machine-readable format, said request identifying an inmate residing in the facility; reading from a scheduling database available times for a contact room; assigning a visit time that coincides with an available time; and designating the contact room as booked at the visit time in the scheduling database.

Also provided is a videoconference visitation system comprising: a visit scheduling server comprising a scheduling database having records comprising an inmate terminal identifier and a variable designating available times for an inmate terminal; a videoconference server connected to a telecommunications network, said network capable of carrying streaming audiovisual data; an inmate terminal connected to the videoconference server via the telecommunications network; a visitation rules module; an electronic payment system; and a web server comprising HTML files constituting a visit scheduling web portal and connected to the visit scheduling server.

Also provided is a memory storage device comprising a set of instructions in machine-readable format which, when read by a computing device, cause the computing device to execute any of the above processes. Further provided is a programmed computing device comprising a set of instructions in machine-readable format which, when read by the computing device, cause the computing device to execute any of the above processes.

### BRIEF DESCRIPTION OF THE DRAWINGS

FIG. 1: This figure is a flowchart diagram of an embodiment of the process in which an off-site videoconference is scheduled.

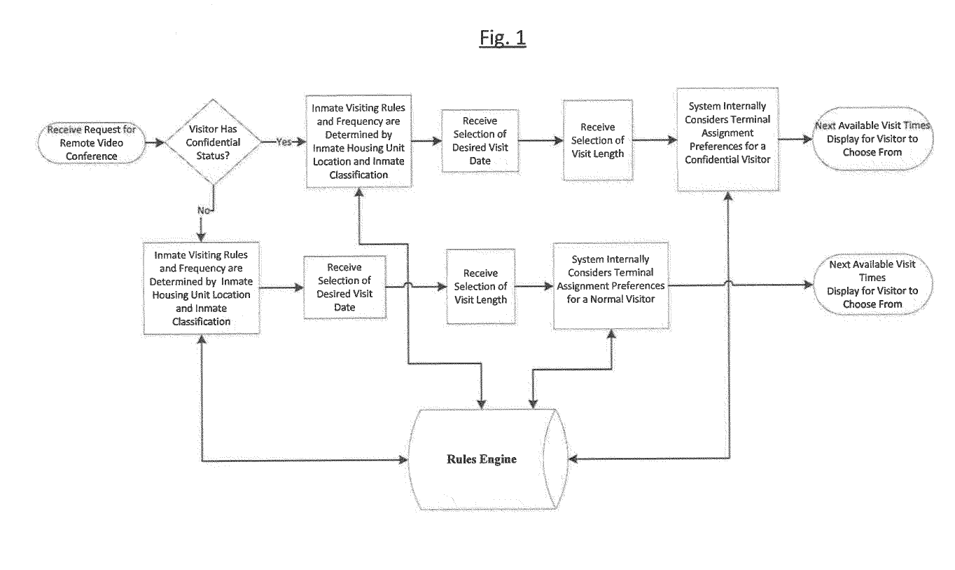

FIG. 2: This figure is a flowchart diagram of an embodiment of the process in which an on-site visit is scheduled.

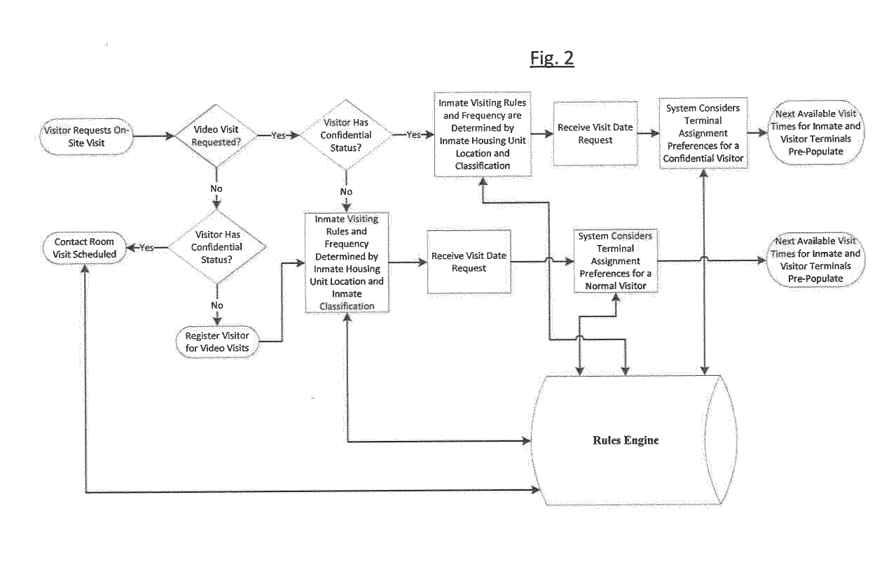

FIG. 3: This figure is a flowchart diagram of an embodiment of the process in which a videoconference visit is scheduled, conducted, and potentially modified in response to a change in location of the visitee.

FIG. 4: This figure is a flowchart diagram of an embodiment of the process for dynamically rescheduling a visit in response to an update from a jail management system.

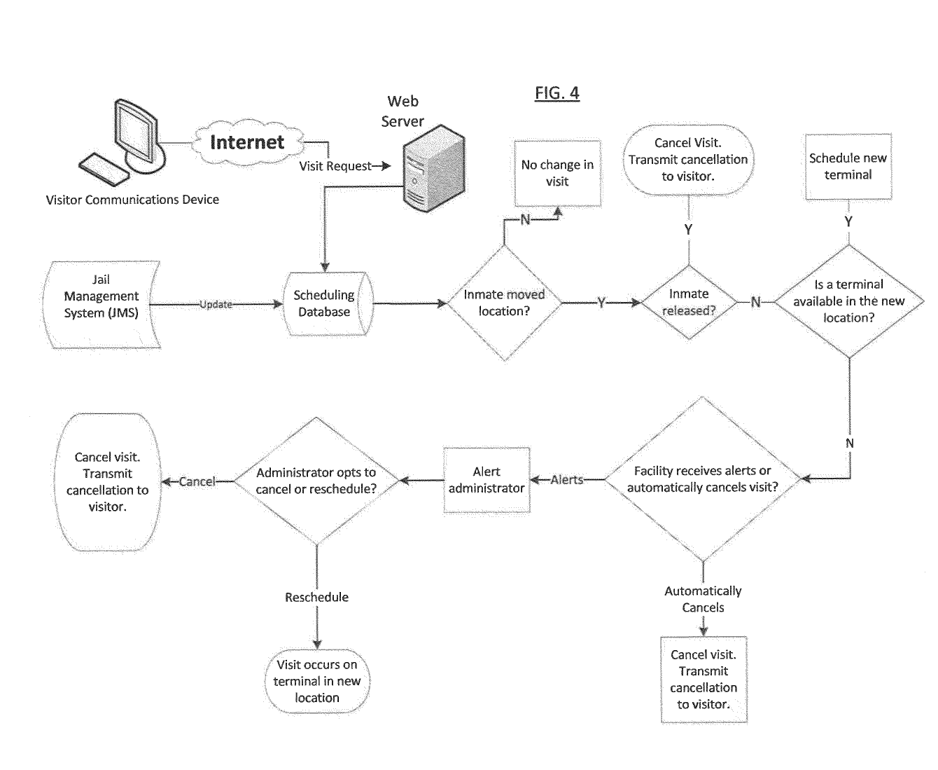

FIG. 5: This figure is a flowchart diagram of an embodiment of the process for scheduling visits for confidential and non-confidential visitors.

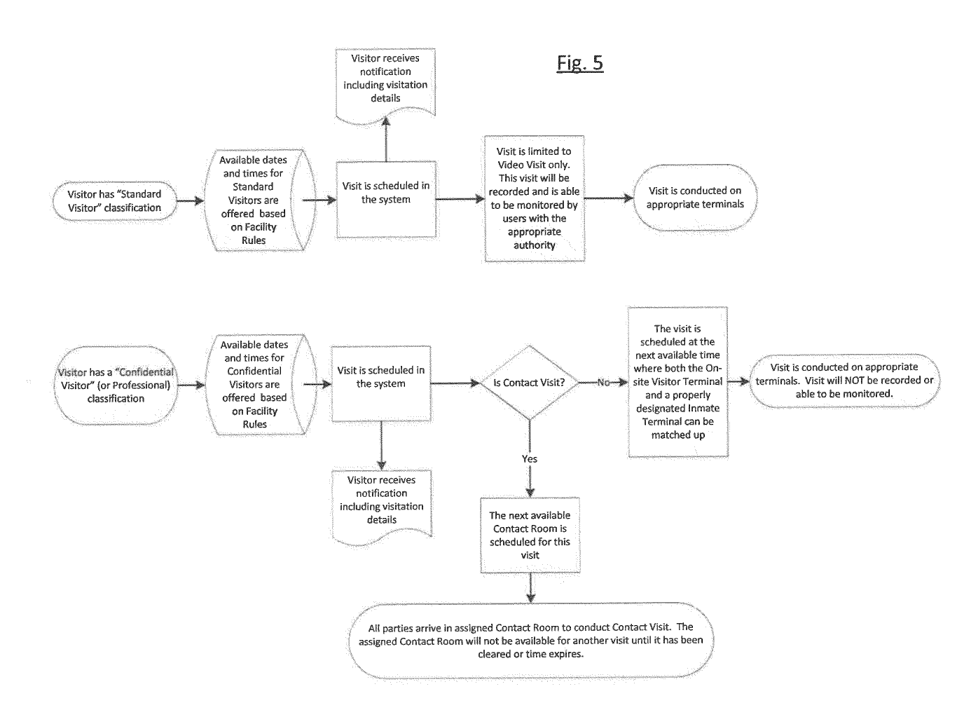

FIG. 6: This figure illustrates an embodiment of the visit management system.

### DETAILED DESCRIPTION

### A. Definitions

With reference to the use of the word(s) “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and/or the following claims.

The term “about” as used herein refers to a value that may vary within the range of expected error inherent in typical measurement techniques known in the art

The term “compute” and permutations thereof, as used herein, refers to the act of performing one or more logical operations by means of a computing device. In no instance should the term “compute” be construed to be an act of human thought.

The term “storage device” as used herein refers to a machine-readable device that retains data that can be read by mechanical, optical, or electronic means, for example by a computer. Such devices are sometimes referred to as “memory,” although as used herein a machine-readable data storage device cannot comprise a human mind in whole or in part, including human memory. A storage device may be classified as primary, secondary, tertiary, or off-line storage. Examples of a storage device that is primary storage include the register of a central processing unit, the cache of a central processing unit, and random-access memory (RAM) that is accessible to a central processing unit via a memory bus (generally comprising an address bus and a data bus). Primary storage is generally volatile memory, which has the advantage of being rapidly accessible. A storage device that is secondary storage is not directly accessible to the central processing unit, but is accessible to the central processing unit via an input/output channel. Examples of a storage device that is secondary storage include a mass storage device, such as a magnetic hard disk, an optical disk, a drum drive, flash memory, a floppy disk, a magnetic tape, an optical tape, a paper tape, and a plurality of punch cards. A storage device that is tertiary storage is not connected to the central processing unit until it is needed, generally accessed robotically. Examples of a storage device that is tertiary storage may be any storage device that is suitable for secondary storage, but configured such that it is not constantly connected to the central processing unit. A storage device that is off-line storage is not connected to the central processing unit, and does not become so connected without human intervention. Examples of a storage device that is off-line storage may be any storage device that is suitable for secondary storage, but configured such that it is not constantly connected to the central processing unit, and does not become so connected without human intervention. Secondary, tertiary, and offline storage are generally non-volatile, which has the advantage of requiring no source of electrical current to maintain the recorded information. Secondary, tertiary, and offline storage may be accessible to the processor as network attached storage (NAS), in which case the storage device will be managed by another processor.

A storage device cannot be construed to be a mere signal, although information may be communicated to and from a storage device via a signal.

The term “telecommunications network” as used herein refers to a network capable of transferring information spatially by conducting signals, such as but not limited to electrical or optical signals. The network itself cannot be construed to be a mere signal. The “optical” signal need not comprise radiation in an optically visible wavelength, and may be in any suitable wavelength. The network may be a packet-switched network (such as a local area network or the Internet) or a circuit-switched network (such as some telephone networks or the global system for mobile communications (GSM)). Information sent via a packet-switched network may be for example electronic mail, an SMS text message, and a digital file sent via file transfer protocol (FTP). Information sent via a circuit-switched network may be for example a voice mail message, a telephone call that initiates an interactive voice response system, a facsimile message, an SMS text message, or a digital file.

The term “processor” or “central processing unit” (CPU) as used herein refers to a software execution device capable of executing a sequence of instructions (“program”). The CPU comprises an arithmetic logic unit, and may further comprise one or both of a register and cache memory.

The term “variable” as used herein refers to a symbolic name corresponding to a value stored at a given memory address on a data storage device (although this address may change). The value may represent information of many types, such as integers, real numbers, Boolean values, characters, and strings, as is understood in the art. As used herein the value of a variable is always stored in a data storage device, and shall not be construed to refer to information only stored in a human mind. Any recitation of a variable implicitly requires the use of a data storage device.

The term “machine-readable format” as used herein refers to a medium of storing information that is configured to be read by a machine. Such formats include magnetic media, optical media, and paper media (punch cards, paper tape, etc.). Printed writing in a human language, if not intended or configured to be read by a machine, is not considered a machine readable format. In no case shall a human mind be construed as “machine readable format.”

The term “database” refers to an organized data structure comprising a plurality of records stored in machine-readable format.

### B. Processes

Processes are provided for advanced and dynamic scheduling of inmate visits. In this context, an “inmate” refers to a person to whom a visitor has limited access. Although the term “inmate” is reminiscent of an imprisoned person, in the context of this disclosure it is to be read to encompass any such access-restricted visitee (the term “penal inmate” will be used when the term is to be limited to an imprisoned person). The inmate may be a person who is confined, such as a person who has been incarcerated in a prison, jail, or administrative detention facility. The person may also be confined as a result of house arrest. In some embodiments of the process the “inmate” may simply be a person who is very inaccessible and has limited access to telecommunications facilities (such conditions could exist in the non-penal context, for example, aboard ship, in a hospital, in a nursing home, or during military operations). In a specific embodiment of the process the inmate is a resident of a traditional criminal detention facility. In another specific embodiment the “inmate” is a person aboard ship. In another specific embodiment the “inmate” is a deployed military person.

The visit refers to a period of two-way communication between the inmate and one or more visitors. The processes provided herein specifically involve visits that occur via a videoconference or a contact visit. Contact visits occur when the inmate and the visitor are present in the same room (the “contact room”). In the penal context contact visits occur under limited circumstances. In many countries a penal inmate may confer with legal counsel during a contact visit. In some countries inmates may have contact visits with other types of professionals, such as physicians, psychiatrists, and religious officials. Some jurisdictions allow the inmate to have contact visits with the inmate's spouse. Videoconference visits occur by any known means of audiovisual communications.

The process comprises receiving a visit request in machine-readable format, wherein the request identifies the inmate. The request may be received via a telecommunication network. In specific embodiments, the request is received over the Internet, or the request is received from a visit management terminal connected to a local area network (LAN). Receipt of requests over the Internet have the advantage of allowing the requestor to transmit the request from virtually anywhere that Internet access exists, including from a mobile computing device. Receipt of requests from a visit management terminal has the advantage of confirming the availability of the visitor at the time the visit is requested. Different methods of handling remote requests (such as Internet requests) and local requests (such as requests from a visit management terminal) are discussed in more detail below.

The request may identify the visitor as well. The visitor may be identified by any suitable means. Some embodiments of the request comprise a visitor identification, such as the visitor's name, the visitor's social security number, electronic mail address, name, date of birth, account number, or any combination of these. The visitor's identity may then be authenticated. One embodiment of the visitor authentication involves receiving a password from the requestor. Other embodiments comprise receiving biometric data from the requestor. Still further embodiments comprise reading an identifying document and comparing the information in the identifying document to known data about the visitor. In an exemplary embodiment the requestor provides the visitor's date-of-birth and social security number, which is then used to locate the visitor in a database of registered visitors. In another exemplary embodiment, the requestor provides the visitor's e-mail address and a password. In the penal context, the database may comprise a record for each visitor, indicating the visitor's visitation rights for a given specific inmate. The visitor's record may also comprise a prohibition variable, indicating whether the visitor is prohibited from scheduling visits. The visitor's record may also comprise a confidant variable, indicating whether the visitor is entitled to confidential visits. If the visitor is entitled to confidential visits, the visitor record may further specify particular inmates for whom confidential visits are allowed (for example, if the visitor is an attorney, she will only be allowed confidential visits with her clients, as opposed to her incarcerated relatives). The visitor's record may also comprise a profession variable, indicating whether the visitor is of a profession that is permitted contact visits. In some embodiments the profession variable and the confidant variable may effectively be unified, indicating that particular professions are allowed confidential contact visits. The visitor's confidential or professional status may also affect available visiting hours.

The scheduling database is a data structure comprising timeslots for venues, in which a timeslot for a venue may be designated as booked or as free (other statuses are also possible). Each venue may be associated with a given location or specific detention facility. The venue may be a contact room or an inmate videoconference terminal. Some embodiments of the scheduling database comprise at least one timeslot pertaining to a contact room and at least one timeslot pertaining to an inmate videoconference terminal. In some situations there may be two (or more) scheduling databases, one containing records pertaining to inmate videoconference terminals and another containing records pertaining to contact rooms.

Some embodiments of the process comprise reading a record for the inmate in an inmate database. The inmate database comprises records indicating at least the identity of the inmate and the location of the inmate. The record may comprise additional information, such as special rules or restrictions on visits for the inmate, a list of permitted visitors for the inmate, or a list of prohibited visitors for the inmate.

One example of a venue is an inmate videoconference terminal. The inmate videoconference terminal is an audiovisual terminal that is accessible to the inmate. In the penal setting the terminal may be located in or near the inmate's housing unit, or at least at the same facility such that the inmate need not leave the controlled area in which he is incarcerated to access the terminal. If the venue is located very close to where the inmate is housed, the venue is said to be “co-located” with the inmate. For example, in the penal context, the venue is “co-located” if the venue is within the inmate's housing unit. In any embodiments of the process described herein, the venue may be co-located with the inmate. One embodiment of the inmate videoconference terminal is a personal computer running videoconferencing software (in this context the term “personal computer” refers to a general purpose computer designed for use by an individual user, equipped with an operating system and one or more software programs). Videoconferencing software is known in the art, for example the products provided as Skype and FaceTime. The videoconferencing software may be web-based, in which case the personal computer will comprise a web browser. The inmate videoconference terminal comprises at least a display, a camera, speakers, a microphone, and a communications interface. The inmate videoconference terminal may be portable or stationary. If the terminal is stationary, it will be located in a terminal room, which in some embodiments of the method may also be the subject of a scheduling database as further described below.

A visit time is assigned based on available times for the venue. The visit time may be assigned pursuant to a selection received from a user, or it may be assigned based on an automated rule set. For example, in some embodiments of the process a request that is made at a detention facility by a visitor who has physically journeyed to the facility will be automatically assigned the next available time for the venue (the assumption being that the visitor wishes to minimize the time she waits after requesting the visit). In this context “visit time” refers to a time on a specific date. The date may be selected when the visit request is made, or it may be assigned by default (for example, if the request is made with the understanding that the visit is to occur that day or as soon as possible).

The process further comprises designating the venue as booked in the scheduling database once a visit time has been arranged. When future visit requests are made the booked venue will not appear as available at that particular visit time.

Some embodiments of the process comprise receiving an update of the inmate's location in machine-readable format from a jail management system (JMS). The JMS may be any that is known in the art. Such systems are used by detention facilities to track the locations of inmates. Inmates are frequently relocated at various stages of the justice system. For example, an inmate may first be held in a local jail after arrest, transferred to a county detention facility while awaiting trail, transferred to a jail in a courthouse on his hearing date, and then transferred to prison. Inmates facing both federal and state charges may be held at various times in both federal and state facilities. Within a given detention facility an inmate may be moved between housing units. The inmate may be segregated from the general prison population for periods of time. Of course, an inmate may always be released from the system entirely.

Updates from the JMS may be scheduled periodically. An update may be received once per day, once per 12 hours, once per 6 hours, once per 4 hours, once per 3 hours, once per 2 hours, once per hour, once per 30 minutes, at least as often as any of the foregoing, and about any of the foregoing. It is to be understood that updates may be received from more than one JMS to allow tracking of inmates in multiple facilities or multiple systems.

If the update from the JMS indicates that the inmate has been released, and if there is a visit scheduled for the inmate, then a cancellation may be transmitted to the visitor notifying her that the visit will not occur. The cancellation notice may be sent, for example, over a telecommunications network. Such a cancellation notice may take any suitable form of telecommunication. In a specific embodiment the cancellation is sent as an SMS text message to a computing device associated with the visitor, such as a mobile phone. In another specific embodiment the cancellation notice is sent as an e-mail message over a packet-switched network to an e-mail address associated with the visitor. Other forms of cancellation notice include an automated voice message delivered via telephone; a message sent via social networking software; and a text message sent to a pager.

In some cases the update from the JMS may indicate that the inmate will be in transit at the visit time; while in transit, an inmate will be unable to participate in the visit. In some embodiments of the process such an update will trigger the transmission of a cancellation notice as described above. In more specific embodiments the cancellation notice comprises a means of rescheduling the visit (a “rescheduling request”). For example, the scheduling database may be searched for available times for a venue at the inmate's new location, and the cancellation notice may contain a list of new available times and instructions as to how the visitor can confirm a new time. Alternatively, the cancellation notice may simply provide some means for scheduling a new visit without providing alternative times. The means for rescheduling may be a universal resource locator code (such as a hypertext markup language link) which enables the visitor to connect to a scheduling system, such as a scheduling web page. It may also take the form of a telephone call that initiates an interactive voice response system, which responds to either or both of key input or voice input. The cancellation may include a rescheduling request in any situation in which the inmate has not been released.

If the venue for the visit was intended to be an inmate videoconference terminal, and the update from the JMS indicates that the inmate will be at a new location at the visit time, the process may further comprise searching in the scheduling database for the new location to find an inmate videoconference terminal co-located at the inmate's new location at the visit time; and if an available terminal is not found, transmitting a cancellation to the visitor via a telecommunications network. If an available terminal is found at the visit time, then no message need be sent to the visitor, unless the visitor planned to participate in the videoconference using a visitor videoconference terminal located in a visitor area of the detention facility.

If the venue for the visit was intended to be a contact room, or if the visitor specified that she intended to use a visitor videoconference terminal at the detention facility, then a cancellation notice may be sent if the JMS update shows a change in location. In such embodiments the cancellation notice will inform the visitor of the inmate's new location. If there is a venue at the new location that is available at the visit time, the cancellation notice may comprise a means for the visitor to confirm that she wishes the visit to occur at the new location. If she fails to so confirm, the visit may be cancelled. The cancellation notice may further comprise means to select another visit time or means to reschedule, as described above.

When a visit is cancelled, the venue may be designated as available (and no longer booked) at the visit time in the scheduling database.

In addition to determining whether the venue is available or booked at the visit time, the process may incorporate other factors into scheduling (or failing to schedule) the visit. Some embodiments of the process comprise reading a record for the inmate in an inmate database, said record comprising a variable indicating a prohibited visitor; and refusing the visit request if the variable indicates that the visitor is a prohibited visitor. A given visitor may be prohibited for various reasons; for example, typically a known criminal co-conspirator of the inmate's will be prohibited from visiting the inmate.

Some embodiments of the process comprise reading a record for the inmate in the inmate database, said record comprising a variable indicating available visit times for the inmate, wherein the visit time is one of the available visit times for the inmate. The inmate's visit times may be based on the housing unit's visiting hours. In many instances the inmate's visit times will be affected by previously scheduled visits. Some further embodiments comprise reading a record for the inmate in the inmate database, the record comprising a variable indicating whether visitation is permitted to the inmate, and allowing the visit if said variable indicates that visitation is permitted to the inmate. Visitation is denied to inmates for various reasons, for example for bad behavior or health reasons.

Certain embodiments of the method comprise determining which available times comply with a set of visitation rules, and denying a visit request that does not comply with the set of visitation rules. The visitation rules may be processed by a program referred to as a “rules engine.” The rules engine compares an available time to one or more allowable times based on a set of rules. The rules may include, for example, visit times that are allowed for the detention facility, visit times that are allowed for the housing unit, and visit times that are allowed for inmates in segregation. There may be separate rules for varying forms of segregation, including protective segregation, medical segregation, psychological segregation, and punitive segregation.

Embodiments of the process that incorporate inmate-specific rules may comprise reading an inmate record from an inmate database, the inmate record comprising a population variable, a location variable, and a visit frequency variable; and computing with a visit algorithm an available time that is the function of one or more of the value of the population variable, the value of the location variable, and the value of the visit frequency variable. In some such embodiments the visit algorithm applies at least one visiting hour rule selected from the group consisting of: a general population rule, a non-general population rule, a housing unit rule, and a facility rule. The non-general population rule may be, for example, a protective custody population rule, an administrative segregation population rule, a disciplinary segregation population rule, a medical segregation population rule, and a mental segregation population rule.

The visit time will comprise a start time for the visit. The visit time may also comprise a duration variable. The duration variable may be based on a start time and an end time. The duration variable may also be based on a designated number of “slots,” each slot involving a set duration. In some embodiments of the process the available times in the scheduling database comprise a start time and a duration, and the selection of the visit time comprises a start time and a duration; some such embodiments further comprise designating the venue as booked from the start time for the duration. In some embodiments of the process the visit time will comprise a buffer period before or after the visit, to allow time for the venue to be vacated in time for the next scheduled visit.

Some embodiments of the process comprise calculating a visit fee. The visitor may be charged to arrange the visit. This may be done for local visits, although this is not customary in the penal context. A fee may be calculated for arranging a remote visit, based on various criteria. Exemplary criteria include a flat fee, a fee per unit time, a fee per slot, a fee per visitor, a surcharge for onsite visits exceeding those mandated by law, and a combination of any of the foregoing. Electronic payment of the fee may be received at the time the visit is requested. Electronic payment may be received by any means known in the art. In some embodiments of the process a record in a visitor database may comprise payment information, such as information to charge a credit card, information to charge a debit card, or information to charge a prepaid account. In such embodiments the visitor's payment instrument may be charged without any further information from the visitor. For other embodiments the payment information is received at the time of the request.

The visit management terminal (such as an administrator terminal) may be used to override the normal process for special situations. Such a special situation could involve a high-priority unscheduled visit. An example of such a visit is a visit by an inmate's attorney to discuss a court deadline. An override command may be received by the visit management terminal to cancel a previously scheduled visit to free up resources for the unscheduled high-priority visit (for example, a previously scheduled videoconference could be cancelled to make the inmate terminal available). The override command could also be used to schedule a visit that would normally violate one or more visitation rules.

Several general embodiments of the process are now described.

1. Automated Process for Scheduling a Confidential Visit

A general embodiment of the process is an automated process for scheduling a confidential visit between a visitor and a resident of a detention facility, said process comprising: receiving a visit request in machine-readable format, said request identifying an inmate residing in the facility; reading a database record associated with the visitor from a visitor database, said record comprising a confidant variable designating that the visitor is entitled to confidential visits; reading from a scheduling database available times for a venue selected from the group consisting of: (i) an inmate videoconference terminal, and (ii) a contact room; receiving a selection of a visit time in machine-readable format that coincides with an available time; designating the venue as booked at the visit time in the scheduling database; and, if the venue is a videoconference terminal, designating the room in the facility in which the inmate terminal is located as private to the inmate at the visit time in the scheduling database.

Contact rooms and videoconference terminals may be configured to allow monitoring. The monitoring may be disabled or deactivated for confidential visits. A contact room or terminal that is dedicated to confidential visits might not be configured to allow monitoring.

The process comprises receiving a selection of a visit time in machine-readable format. The selection may be received by the same means as the visit request. For example, in some embodiments the visit request will be received over a telecommunications network, and the selection of the visit time will also be received over the telecommunications network. Likewise, in some embodiments the visit request will be received via a visit-management terminal, and the selection of the visit time will also be received over the visit-management terminal. The selection of the visit time may be preceded by transmitting one or more available times, as read from the scheduling database. In such embodiments the visitor (or his proxy) is presented with the one or more available times, and then has the opportunity to confirm one.

If the venue is an inmate videoconference terminal, then the room in which the terminal is located will be designated as “private” in the scheduling database. This will allow the inmate to participate in a private visit via videoconference in an area in which the visit cannot be overheard by others. This allows the use of rooms that are not always private for private visits. For example, in a penal setting the videoconference terminals may be located in the day room of a housing unit, which is not usually a private place. If a private visit is booked on one of the videoconference terminals in the day room, then they day room will be designated as “private” in the scheduling database. Persons other than the inmate involved in the visit will not be allowed in the day room during the time of the private visit. A day room is just one example of a room that could house a videoconference terminal.

Some embodiments of the process comprise the use of a scheduling database that contains records both for videoconference terminals and for contact rooms. This allows the integrated scheduling of videoconference visits and contact visits. In some embodiments the videoconference and contact scheduling databases will be separate data structures; however, the process will still realize the advantages of allowing the automated scheduling of contact and videoconference visits.

Further embodiments of the process may comprise receiving an update of the inmate's location in machine-readable format from a jail management system, wherein the update indicates that the inmate has been moved to a new location or that the inmate has been released, as described above. If the venue is a contact room, and if the inmate's location has been changed, the process may comprise searching in a scheduling database for the new location to find a contact room co-located at the inmate's new location at the visit time; and if an available contact room is found, transmitting a rescheduling request with the new location to the visitor via a telecommunications network. If necessary, the new contact room will be designated as private to the inmate in the scheduling database. If the venue is an inmate videoconference terminal, then a cancellation will only be advantageous if a search of the scheduling database shows that no inmate videoconference terminal is available at the visit time in the new location. However, as discussed above, in some circumstances the visitor may have scheduled a visit to be conducted using a visitor videoconference terminal located in the detention facility; in such cases a cancellation may be sent as described for a contact visit if the inmate changes locations.

2. Automated Process for Dynamically Updating a Visit

A further general embodiment of the process comprises receiving a visit request in machine-readable format identifying an inmate residing in the facility; reading available times from a scheduling database for a venue; assigning a visit time that coincides with an available time; designating the venue as booked at the visit time in the scheduling database; and receiving an update of the inmate's location in machine-readable format from a jail management system, wherein the update indicates that the inmate has been moved to a new location.

If the venue is a videoconference terminal, the process may further comprise searching for an available videoconference terminal at the new location at the visit time in a scheduling database for the new location. If an available terminal at the visit time is not found, this embodiment of the process will comprise searching for additional available times in the scheduling database for the new location; and transmitting a cancellation to the visitor via a telecommunications network, said cancellation comprising a rescheduling request showing at least one available time.

If the venue is a contact room, the process may further comprise searching for an available contact room at the new location at the visit time in a scheduling database for the new location; and transmitting a cancellation to the visitor via a telecommunications network, said cancellation comprising a rescheduling request showing the new location.

The scheduling database for the new location may be integrated with the scheduling database for the inmate's prior location (in which case they are in essence the same database) or it may be a distinct data structure. As is known in the art, records from distinct databases can be accessed and processed without undue difficulty compared to accessing and processing records from a single database.

Some embodiments of the process comprise receiving an additional request for an additional visitor to participate in the videoconference visit in machine-readable format, said additional request comprising an additional identifier of the additional visitor; and sending an electronic invitation to the additional visitor via a telecommunications network, said invitation comprising the visit time. The additional visitor may participate in the visit either using the same videoconferencing terminal as the first visitor, or using a separate terminal. If the additional visitor uses a separate terminal her terminal will establish the videoconference independently from the first visitor's terminal. The electronic invitation may be any type of electronic message that is amenable to automated composition and delivery, such as those types of messages that are described as suitable for the cancellation notice above. The invitation may comprise means to accept the visit, such as instructions to reply or a universal resource locator link. Of course, additional invitations may be transmitted to additional visitors. A fee may then be received from the requestor for the additional visitor, or the additional visitor may be given means to submit payment for the visit. The process may further comprise searching a visitor database for each visitor to authenticate the visitor's identity or establish that the visitor is permitted to participate in the visit.

Some embodiments of the process comprise reading a database record associated with the visitor from a visitor database, said record comprising a confidant variable designating that the visitor is entitled to confidential visits; and designating the visit a confidential visit in the scheduling database. Such confidential visits may be conducted as described above (i.e., the videoconference will not be subject to recording or monitoring). Further embodiments of the process may comprise designating the terminal room in the facility as private to the inmate at the visit time in the scheduling database, also as described above.

Some embodiments of the process combine the ability to schedule a videoconference visit, the ability to schedule a contact visit, and the ability to automatically reschedule visits based on updates from a JMS. One exemplary embodiment of such a process comprises receiving a visit request in machine-readable format identifying an inmate residing in the facility; reading available times from a scheduling database for a venue selected from the group consisting of a videoconference terminal, or a contact room; assigning a visit time that coincides with an available time; designating the venue as booked at the visit time in the scheduling database; receiving an update of the inmate's location in machine-readable format from a jail management system, wherein the update indicates that the inmate has been moved to a new location; if the venue is a videoconference terminal: (i) searching for an available videoconference terminal at the new location at the visit time in a scheduling database for the new location; (ii) if an available terminal at the visit time is not found, searching for additional available times in the scheduling database for the new location; and transmitting a cancellation to the visitor via a telecommunications network, said cancellation comprising a rescheduling request showing at least one available time; if the venue is a contact room: (i) searching for an available contact room at the new location at the visit time in a scheduling database for the new location; and (ii) transmitting a cancellation to the visitor via a telecommunications network, said cancellation comprising a rescheduling request showing the new location. Of course, whenever a new venue is found, it will be designated as booked unless a cancellation or rescheduling request is required. In cases in which a the visitor must confirm a change in scheduling, the venue will be designated as booked if the visitor so confirms.

3. Process for Scheduling a Local Visit

A general embodiment of the method comprises receiving a local visit request. The local visit will involve either a contact visit (in which case the venue is a contact room) or a local videoconference between an inmate videoconference terminal and a visitor terminal in a visitor area of the detention facility. In some versions of this general embodiment the visit time is not selected by the visitor, but is automatically assigned. In a more specific embodiment the visit time is assigned the next available time for the venue.

In some embodiments, updates may be received from a JMS, and the local visit adjusted accordingly. This general embodiment may further comprise receiving an update of the inmate's location in machine-readable format from a jail management system, wherein the update indicates that the inmate has been moved to a new location or that the inmate has been released; if the inmate has been released, transmitting a cancellation to the visitor via a telecommunications network; if the inmate has been moved to a new location: (i) searching a scheduling database for a new venue selected from the group consisting of a videoconference terminal at the new location that is available at the visit time, and a contact room at the new location that is available at the visit time; (ii) if an available new venue is found, designating said new venue as booked in the scheduling database for the new location at the visit time; or (iii) if an available venue is not found, transmitting a cancellation to the visitor via a telecommunications network.

In cases in which an update from a JMS indicates that the inmate has been moved, it may be necessary to alert the visitor. The scheduling database for the inmate's new location will be searched for a venue that is available at the visit time. If a venue is available, then the new venue is designated as booked and a message is sent via a telecommunications network to the visitor requesting confirmation of the new location for the visit as described above. If no venue is available, then a cancellation will be sent to the visitor as described above.

When the local visit was scheduled as a videoconference between the inmate and the visitor at a terminal in the visitor area of the facility, it may be necessary to send a cancellation to the visitor if the originally booked terminal at the facility is not configured to connect to inmate terminals in other facilities. In such a case the cancellation may include a rescheduling request, as explained above. In some cases the terminal in the visitor area of the facility may be configured to connect to inmate terminals in other facilities. If this is the case, and if an inmate terminal is available at the inmate's new location at the visit time, no cancellation notice need be transmitted to the visitor.

Often a request for a local visit will be made at the detention facility itself. In such cases the request may be received from a scheduling control terminal. The scheduling control terminal is typically operated by an employee of the detention facility and is used to schedule visits as visitors arrive (of course, the operator need not be employed by the facility). In some embodiments of the process, when a visit request is made at the detention facility the visit time will automatically be assigned the next available time for a venue that is accessible to the inmate. In some cases the venue will be available at the time the visit request is made. In such a case, some embodiments of the process will comprise assigning a visit time that is the next available time. One such embodiment comprises receiving a local visit request in machine-readable format identifying an inmate residing in the facility; reading from a scheduling database available times for a venue; assigning a visit time that coincides with the next available time; and designating the venue as booked at the visit time in the scheduling database.

Some embodiments will comprise assigning an immediate visit time. If the visit time is an immediate visit time, the venue will be designated as booked immediately in the scheduling database. Generally there will be a delay in summoning the inmate to the venue when the venue is booked immediately. If this is the case for a local videoconference visit, then a message may be sent to the scheduling control terminal when the inmate arrives at the venue, and the visitor may then be notified that the visit may begin.

However, assignment of an immediate or first-available visit time is not obligatory in this milieu. In further embodiments a selection may be received for a visit time that coincides with one or more available times in machine-readable format; and assigning a visit time that is the selected visit time.

When the visit is a local videoconference visit, the process may comprise searching for a record of a visitor videoconference terminal at the facility that is available at the visit time in a visitor terminal scheduling database. There may be situations in which the availability of visitor terminals is more limiting than the availability of inmate terminals and vice versa. In such embodiments the visit time may be scheduled if no visitor terminal is available at the initially established visit time.

Steps for designating and conducting a confidential visit may be followed as have been described above. When a visitor who is entitled to confidential visits requests a confidential visit at the detention facility (an “unannounced visit”), it may be necessary to override the scheduling database or any rule set that controls available visitation times. In such cases the user of the scheduling control terminal may cancel existing visits in the scheduling database to free up a venue for an unannounced confidential visit. The user of the scheduling control terminal may also schedule a visit in violation of normal visitation rules, for example outside of normal visitation hours for the inmate's housing unit. As another example, an attorney visit may be “manually” arranged for an inmate who has lost visitation privileges due to bad behavior.

4. Process for Scheduling a Contact Visit

Another general embodiment of the process comprises receiving a contact visit request in machine-readable format, said request identifying an inmate residing in the facility; reading from a scheduling database available times for a contact room; assigning a visit time that coincides with an available time; and designating the contact room as booked at the visit time in the scheduling database.

This general embodiment may comprise arranging a confidential visit, as described elsewhere in this disclosure. This general embodiment may comprise receiving an update from a JMS, and taking appropriate action in response (such as rescheduling the venue or sending a cancellation notice). As explained in the previous section, in some cases, when the contact visit is requested while the visitor is present at the detention facility, the process will automatically comprise assigning the visit time to coincide with the next available time. Further steps may occur to establish and arrange a confidential visit, which may further involve scheduling the terminal room to be private to the inmate at the visit time.

### C. Systems and Devices

Systems and devices are provided capable of performing the processes discussed above. A general embodiment of the system comprises: a visit scheduling server comprising a scheduling database having records comprising an inmate terminal identifier and a variable designating available times for an inmate terminal; a videoconference server connected to a telecommunications network, said network capable of carrying streaming audiovisual data; an inmate terminal connected to the videoconference server via the telecommunications network; a visitation rules engine; an electronic payment system; and a web server comprising HTML files constituting a visit scheduling web portal and connected to the visit scheduling server.

In this context the term “server” refers to a server device, comprising a storage device on which software or data is stored (as opposed to the usage of the term “server” to refer to the software itself). Additional servers of each type may be present in the system for purposes that are well understood in the art, such as increasing storage capacity or providing backup redundancy. A single server device may also function as a server for more than one purpose; for example it is conceivable that one server machine will function as the videoconference server and the visit scheduling server, in which case the server machine will contain the scheduling database and videoconference software. It is also contemplated that the web server could be the same device as the videoconference server; this could particularly be the case if the videoconferencing software is a browser-run program, for example a program in Java or Flash.

The visit scheduling server provides access to the scheduling database, as well as maintaining the scheduling database. The scheduling server may further comprise software for revising the contents of the scheduling database. Such software will be capable of one or more functions described in the method above, for example determining which venues are available, determining at what times venues are available, and applying rules to the scheduling of visits.

The scheduling database comprises at least a record comprising an inmate terminal identifier and a variable designating available times for an inmate terminal. The variable designating available times may be of any suitable type. For example, if the system breaks up a period of time (such as a day or a week) into a number of time slots of equal duration, the variable may be as simple as an integer corresponding to the time slot. Higher level variables, such as date and time variables, may also be used. The record also comprises a terminal identifier designating a particular terminal. The record may further comprise information about the location of the inmate videoconference terminal. Location information may include the facility where the terminal is located, the housing unit where the terminal is located, or the room where in the terminal is located. All types of location information are useful for many reasons as understood in the art. For example, facility information may be used to trigger the application of a rule set that is specific to the facility, and may be used to confirm that the inmate who is the subject of the visit request is present at the facility. Exemplary uses of housing unit information include triggering a housing unit rule set. Exemplary uses of room information include determining whether a videoconference terminal is in a suitable location for a confidential visit.

In some cases the scheduling server (or a separate server) will be capable of scheduling contact rooms. In such cases records corresponding to contact rooms will either be part of the scheduling database or part of a distinct contact room scheduling database. Each contact room record will contain a room identifier and a variable designating available times for the room. The record may further comprise information about the location of the room. Such information will be used for the same purposes as discussed above for the analogous variables in records for the videoconference terminals.

The videoconference server contains software capable of providing and receiving live audiovisual data. In some embodiments additional software may reside on a computing device being used by the visitor that interacts with the software on the videoconference server. In other embodiments all or nearly all of the software required to run the videoconference is on the videoconference server. Such videoconferencing software is well known in the art, and need not be recited in detail here to enable those of ordinary skill in the art to use such software.

The telecommunications network is capable of carrying live audiovisual data. Many such telecommunications networks currently exist, and for the purposes of this disclosure the network may be wireless or wired, electronic or optical. In a specific embodiment of the system the telecommunications network is the Internet.

As stated above, the inmate videoconference terminal comprises at least a display, a camera, speakers, a microphone, and a communications interface. The inmate videoconference terminal may be portable or stationary. If the terminal is stationary, it will be located in a terminal room, which in some embodiments of the method may also be the subject of a scheduling database as further described below. A certain embodiment of the inmate videoconference terminal comprises a computing device located in a detention facility and accessible to one or more inmates, said device comprising a web browser and connected to the web server. A specific embodiment of the inmate terminal is a personal computer coupled to peripheral devices including the speakers, the camera, the microphone, the display, and a communications interface. If the videoconference is web-mediated, then the personal computer will comprise a web browser.

In some embodiments of the system, the inmate terminal is part of a LAN at the facility. The LAN may additionally comprise any conventional components. Examples of such components include a firewall router, a switching system, various types of data transmission lines, and a wireless router. The LAN may further comprise a scheduling terminal, which allows immediate scheduling of visits by a user at the facility.

The visitation rules module is software that applies one or more rules set to restrict at least one of the visit time or the venue. The restriction may be used to limit the choices available to the visitor when the request is made. For example, this may take the form of presenting to the prospective visitor a list of available times that have been culled by the rules module. It may also take the form of rejecting a time or venue that has been selected by the visitor and requesting another selection.

As stated above, the rules engine compares an available time to one or more allowable times based on a set of rules. The rules may include, for example, visit times that are allowed for the detention facility, visit times that are allowed for the housing unit, and visit times that are allowed for inmates in segregation. There may be separate rules for varying forms of segregation, including protective segregation, medical segregation, psychological segregation, and punitive segregation.

The electronic payment system may be any known in the art. Suitable systems include systems for processing credit card charges, debit card charges, pre-paid account charges (including in the form of pre-paid cards), and electronic fund transfers. Such processing can be performed based on payer input via a web page, an interactive phone system, a text message, etc.

The web server refers to the hardware involved in hosting a website (as opposed to the usage of this term to refer to software for website hosting). The web server delivers web pages on request to clients using the Hypertext Transfer Protocol (HTTP). This will involve delivery of HTML documents, as well as any additional content that may be included by a document, such as images, style sheets, and scripts. Requests for web content are made by a user agent, such as a web browser or a web crawler. In addition, the web server will be configured to receive content from clients. Such content may be received as a web form, uploaded file, or other web-based input as is known in the art. Server-side scripting may also be provided by the web server. The web server will collect information from the visitor, such as the identity of the inmate, and transmit such information to the scheduling server to schedule the visit. Any other information that might be received as part of the visit request may be similarly exchanged between the web server and the scheduling server.

Some embodiments of the system comprise a plurality of visitor terminals located in a public area of the detention facility connected to the videoconference server. The visitor terminals are provided for visitors who wish to engage in a videoconference visit while at the same facility as the inmate. Such visitors often request the visit only after they arrive at the facility. The videoconference may then be conducted via a closed-circuit video system, although it may be conducted by any other means disclosed herein. The system may further comprise a visitor terminal scheduling module to allow the efficient allocation of the visitor terminals. Under some circumstances the availability of visitor terminals may be more limiting than the availability of inmate terminals, in which case the scheduling of the visit will be more dependent on the availability of a visitor terminal than on the availability of an inmate terminal. In some embodiments of the system the visitor terminals located at a given facility will be configured to conduct videoconferences with inmate terminals in other facilities. Consequently, a visitor may use the nearest convenient visitor terminal and conduct a videoconference with an inmate at another facility. The system may comprise an administrator terminal connected to the scheduling server. The administrator terminal may be a visit management terminal as described above. The administrator terminal functions to modify visits, regardless of the rules engine or the current state of the scheduling database. As explained above, situations will inevitably arise in which a previously established visit must be altered, or in which the usual visitation rules must be suspended. In such cases input will be received from the administrator terminal making such changes.

Devices are also provided for automating the scheduling of a visit. A general embodiment of the device is a memory storage device comprising a set of machine-readable instructions which, when read by a general purpose computer, are configured to cause the computer to perform the steps of any of the processes disclosed herein. The memory storage device comprises non-transient machine-readable media. Another general embodiment of the device is a general purpose computer comprising a set of machine-readable instructions which, when read by the computer, are configured to cause the computer to perform the steps of any of the processes disclosed herein.

### D. Examples

### 1. Exemplary Embodiment of the Process

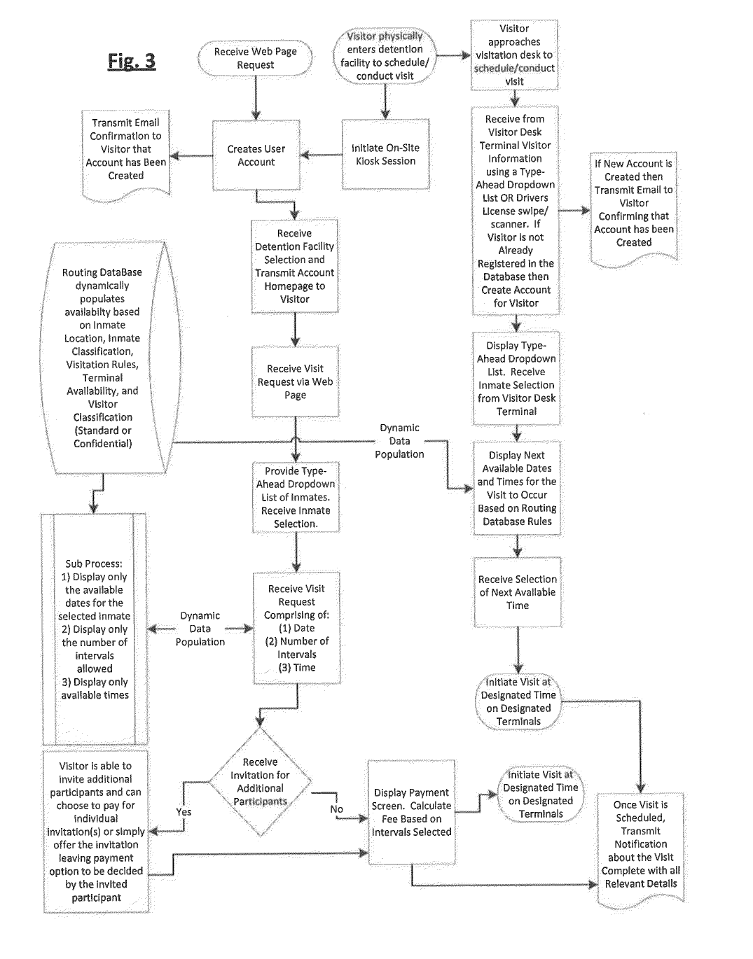

One exemplary embodiment of the process allows remote video visitation to be conducted in 4 simple steps: create a visitor account online; receive an inmate selection from the visitor; receive a selection of date and time for the visit, and optionally selections of additional visitors; and process payment for the visit. FIG. 3 illustrates the flow of such an embodiment of the process.

Account creation only requires entry of a valid email address and password. CAPTCHA (Completely Automated Public Turing test to tell Computers and Humans Apart) technology is used to ensure human entry. Inmate selection utilizes a file that is received from a JMS and updated every 30 minutes. It provides the inmate location, classification, and status. Date and time selections are provided by a sophisticated multi-step sub-process. Visits are routed to specific visitation terminals based on inmate location, inmate classification, terminal designation, and terminal availability. Double-booking of inmate terminals is prohibited. The visitors do not choose a terminal assignment, as it is done intelligently based on the routing parameters that the facility establishes. Decision trees ensure that terminals are not double booked and visitation times can be accommodated in the most efficient manner for the facility procedures and staff. Payment is processed using the Authorize.net Payment Gateway API. The visitor is shown a brief training video after payment, to assist the visitor in conducting the visit.

Account creation, scheduling, and payment occur via a public website. In addition, a back-end controller dashboard is provided to enable an administrator to view and manage visits if needed, and to access reports.

The scheduling system integrates with the video visitation system via an application programming interface (API). A “visitation controller dashboard” shows the administrator all upcoming visits listing them in descending order of visit time. The “facility controller” has the ability to quit visits, end visits, change volume controls in visits, change resolution settings in visits, update the time remaining in the visits, act as a blind monitor, and join visits.

The scheduling system intelligently combines both the inmates' classification level and housing locations and only populates the visitor schedule with dates and times available for the inmate to visit based on the facility rules. A visitor to an incarceration facility simply goes to the web site, creates an account, selects a facility and inmate, and schedules the meeting. At the appropriate time, the visitor logs into their web account and the visit will begin at the scheduled time.

The inmate visitation station comprises a personal computer in a secure cabinet, a monitor, a web cam, and a telephone hand set. The inmate visitation stations are installed in the housing units in the penal facility. A given station displays the daily scheduled visits for that station by the inmate's name, without identifying the name of the visitor. At the scheduled visit time, the inmate accesses the visitation station and the videoconference launches.

A user interface is provided to the staff of the penal facility. On the left side of the screen is a navigation panel. A “controller dashboard” shows all visits, and whether each visit is confidential. It also allows an administrator to view the actual participants in a given video visit. The administrator can join the meeting blind or become an active participant. The administrator has the ability to update the meeting, quit the meeting or end the meeting. The visits can be sorted by any variable in a record associated with the visit. Such sort criteria include: status of visit as active or completed, inmate name, time left in an active visit, confidential status of the visitor, terminal identifier, housing unit, local versus remote visits, and facility of the inmate.

A daily visitation report can be viewed and filtered by day or by housing location. The type of visit is assigned a color code on the screen. Remote visits are green, on-site video visits are yellow, and on-site in person visits are purple. The scheduling system takes all three types of visits into account and only permits available stations to populate the date and time of a meeting. Confidential visits are shown in red. There is an administrative override which allows the administrator to override the facility scheduling rules to relocate a visit to a different time or station location.

All non-confidential visits are recorded. Walk up visitors can be scheduled in the same system.

The web browser-based visitation software and system can perform all functions on any platform, so long as the platform is capable of running an HTML-based web browser.

This embodiment of the process removes the need for on-site servers or on-site visits, allowing visitors to videoconference from a remote location using a personal computer with a web cam that is connected to the Internet while using a standard web browser. The visitor simply creates an account online, schedules the visit, and pays a fee.

### 2. Exemplary Embodiment of the System

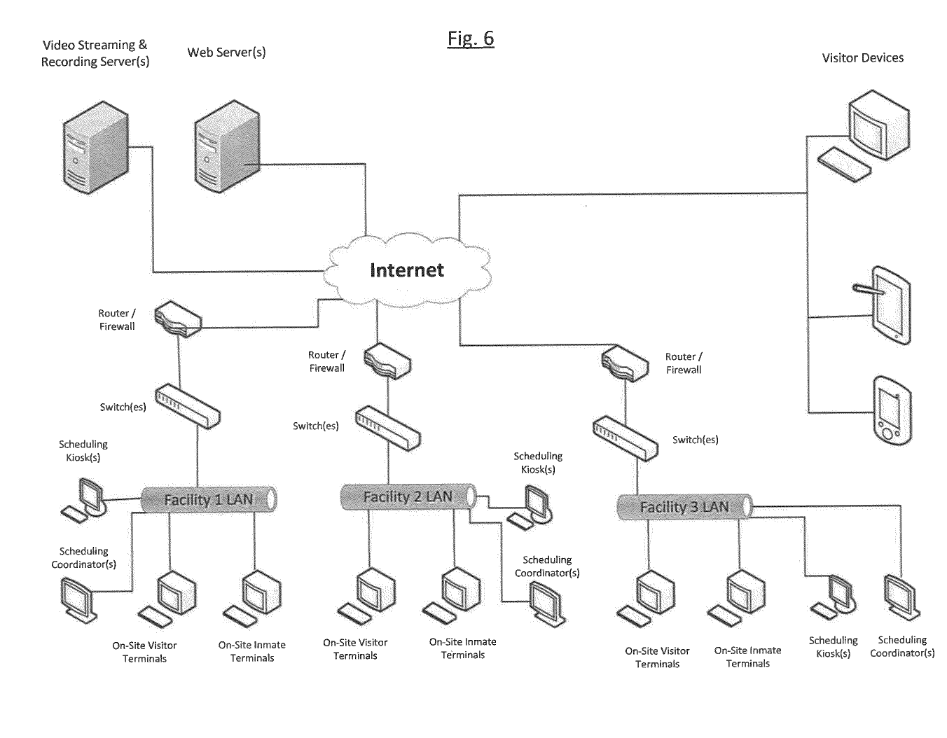

An exemplary embodiment of the system is illustrated in FIG. 6. The system comprises a video streaming and recording server (videoconference server) and a web server, both connected to the Internet. By way of the Internet the servers are connected to local area networks (LAN) at penal facilities. At each facility, the LAN connects an on-site scheduling kiosk, a scheduling coordinator (administrator) terminal, an onsite visitor terminal, and an onsite inmate terminal. Any facility will actually have a plurality of onsite visitor terminals and onsite inmate terminals. Visitors will access the web server via the internet, using any of a variety of computing devices. The visitor's computing device can serve as a web browsing device to schedule a visit, as a videoconference terminal for conducting the visit, or both.

### 3. Exemplary Rules-Engine Rule Set

Table 1 presents an exemplary set of rules suitable to be applied by the rules engine in the processes disclosed herein. In Table 1, the following abbreviations are used: “DR Terminal” refers to “Day Room Terminal”—terminals that exist inside the pods where inmates are housed; “MP Terminal” refers to a “Multi-Purpose Room Terminal”—terminals that exists in private (closed door room) inside pods where inmates are housed; and “AC Terminal” refers to an “Area Control Room Terminal”—terminals that exists in private (closed door room) outside the pods where inmates are housed.

TABLE 1

| | | Max. | | | | |
|---|---|---|---|---|---|---|
| | | Frequency - | Terminal | | | |
| | | Normal | Placement - | Terminal | Normal Visitation | Confidential |
| Identifier | Description | Visits | Normal Visits | Preference | Hours | Visitation Hours |
| remote-1 | Housing Unit 1 | 2 per day | DR, MP, AC | 1 | Monday through | Daily: |
| | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote-2 | Housing Unit 2 | 2 per day | DR, MP, AC | 1 | Monday through | Daily: |
| | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote-3 | Housing Unit 3 (Mental | 1 per week | DR, MP, AC | 1 | Friday: | Daily: |
| | Segregation) | | | | 7:30 pm-10:30 pm | 7:30 am-11:00 am |
| | | | | | | 1:30 pm-4:00 pm |
| | | | | | | 7:30 pm-11:00 pm |
| remote-4 | Housing Unit 4 | 1 per week | AC | 2 | Monday through | Daily: |
| | | | | | Friday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote-6 | Housing Unit 6 | 1 per week | DR, MP, AC | 2 | Friday: | Daily: |
| | | | | | 7:30 pm-10:30 pm | 7:30 am-11:00 am |
| | | | | | | 1:30 pm-4:00 pm |
| | | | | | | 7:30 pm-11:00 pm |
| remote-7 | Housing Unit 7 | 2 per day | DR, MP, AC | 4 | Monday through | Daily: |
| | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote-8 | Housing Unit 8 | 2 per day | DR, MP, AC | 4 | Monday through | Daily: |
| | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote-9 | Housing Unit 9 | 2 per day | DR, MP, AC | 4 | Monday through | Daily: |
| | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote- | Housing Unit 11 | 2 per day | DR, AC | 3 | Monday through | Daily: |
| 11 | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote- | Housing Unit 12 | 2 per day | DR, AC | 3 | Monday through | Daily: |
| 12 | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote- | Housing Unit 13 | 2 per day | DR, AC | 3 | Monday through | Daily: |
| 13 | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote- | Housing Unit 14 | 2 per day | DR, AC | 3 | Monday through | Daily: |
| 14 | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote- | Housing Unit 15 | per day | DR, AC | 3 | Monday through | Daily: |
| 15 | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote- | Housing Unit 16 | 2 per day | DR, AC | 3 | Monday through | Daily: |
| 16 | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |
| remote- | Housing Unit 17 | 2 per day | DR, AC | 3 | Monday through | Daily: |
| 17 | | | | | Saturday: | 7:30 am-11:00 am |
| | | | | | 7:30 am-10:30 am | 1:30 pm-4:00 pm |
| | | | | | 5:00 pm-6:00 pm | 7:30 pm-11:00 pm |
| | | | | | 7:30 pm-10:30 pm | |

### E. Conclusions

It is to be understood that any given element of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and are capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. §1.77 or otherwise to provide organizational queues. These headings shall not limit or characterize the invention(s) set forth herein.

1-26. (canceled)

27. A videoconference visitation system comprising:
(a) a visitation rules engine;
(b) a visit scheduling server comprising a scheduling database having records comprising an inmate terminal identifier and a variable designating available times for an inmate terminal, and configured to automatically schedule visits in cooperation with the visitation rules engine;
(c) a videoconference server connected to a telecommunications network, said network capable of carrying streaming audiovisual data;
(d) an inmate videoconference terminal connected to the videoconference server via the telecommunications network;
(e) an electronic payment system;
(f) a web server comprising HTML files constituting a visit scheduling web portal and connected to the visit scheduling server;
(g) a web server comprising HTML files constituting a videoconference system; and
(h) a fully automated rescheduling system connected to read data from a jail management system to track the movement of inmates and reschedule visits in cooperation with the visitation rules engine.

28. The system of claim 27 comprising: a computing device located in a detention facility and accessible to one or more inmates, said device comprising a web browser and connected to the web server.

29. The system of claim 27 comprising a plurality of visitor terminals located in a public area of the detention facility connected to the videoconference server.

30. The system of claim 27 comprising an administrator terminal connected to the scheduling server.

31. The system of claim 27, configured or programmed to carry out an automated process for scheduling a visit between a visitor and a resident of a detention facility, said process comprising:
(a) receiving a visit request in machine-readable format identifying an inmate residing in the facility;
(b) performing a fully automated scheduling process using a system other than a jail management system, the process comprising:
(i) reading an inmate record from an inmate database, the inmate record comprising a visitation rules variable;
(ii) computing with a visit algorithm available times as a function of the value of the visitation rules variable;
(iii) reading available times from a scheduling database for a venue that is an inmate videoconference terminal;
(iv) assigning a visit time that coincides with an available time from the scheduling database and the available times as a function of the value of the visitation rules variable; and
(v) designating the venue as booked at the visit time in the scheduling database;
(c) receiving an update of the inmate's location in machine-readable format from a jail management system;
(d) if the update indicates that the inmate has been moved to a new location within the facility, performing a fully automated rescheduling process using a system other than a jail management system, the process comprising:
(i) searching for an available inmate videoconference terminal at the new location at the visit time in a scheduling database;
(ii) if an available inmate terminal at the new location at the visit time is found, designating the available inmate terminal at the new location as booked at the visit time; or
(iii) if an available inmate terminal at the visit time is not found, transmitting an electronic cancellation to the visitor via a telecommunications network;
(e) and if the visit is not cancelled, conducting a video visit between the booked inmate terminal and a visitor computing device comprising a web browser via said web browser at the visit time.

32. The system of claim 27, configured or programmed to carry out an automated process for scheduling a visit between a visitor and a resident of a detention facility, said process comprising:
(a) receiving a visit request in machine-readable format identifying an inmate residing in the facility and requesting a visit type selected from the group consisting of: an offsite video visit, and onsite video visit, and a contact visit;
(b) performing a fully automated scheduling process comprising:
(i) reading an inmate record from an inmate database, the inmate record comprising a visitation rules variable;
(ii) computing with a visit algorithm available times as a function of the value of the visitation rules variable;
(iii) reading available times from a scheduling database for a venue selected from the group consisting of: an inmate videoconference terminal and a contact room;
(iv) assigning a visit time that coincides with an available time from the scheduling database and the available times as a function of the value of the visitation rules variable;
(v) designating the venue as booked at the visit time in the scheduling database; and
(vi) if the visit type is an onsite video visit, designating an onsite visitor videoconference terminal as booked in a scheduling database;
(c) receiving an update of the inmate's location in machine-readable format from a jail management system;
(d) if the update indicates that the inmate has been moved to a new location within the facility, performing a fully automated rescheduling process comprising:
(i) searching for an available venue at the new location at the visit time in a scheduling database;
(ii) if an available venue at the new location at the visit time is found, designating the available venue at the new location as booked at the visit time; or
(iii) if an available venue at the visit time is not found, transmitting an electronic cancellation to the visitor via a telecommunications network;
(e) and if the visit is not cancelled, conducting a video visit between the booked inmate terminal and a visitor computing device comprising a web browser via said web browser at the visit time.

33. An automated process for scheduling a visit between a visitor and a resident of a detention facility, said process comprising:
(a) receiving a visit request in machine-readable format identifying an inmate residing in the facility;
(b) performing a fully automated scheduling process using a system other than a jail management system, the process comprising:
(i) reading an inmate record from an inmate database, the inmate record comprising a visitation rules variable;
(ii) computing with a visit algorithm available times as a function of the value of the visitation rules variable;
(iii) reading available times from a scheduling database for a venue that is an inmate videoconference terminal;
(iv) assigning a visit time that coincides with an available time from the scheduling database and the available times as a function of the value of the visitation rules variable; and
(v) designating the venue as booked at the visit time in the scheduling database;
(c) receiving an update of the inmate's location in machine-readable format from a jail management system;
(d) if the update indicates that the inmate has been moved to a new location within the facility, performing a fully automated rescheduling process using a system other than a jail management system, the process comprising:
(i) searching for an available inmate videoconference terminal at the new location at the visit time in a scheduling database;
(ii) if an available inmate terminal at the new location at the visit time is found, designating the available inmate terminal at the new location as booked at the visit time; or
(iii) if an available inmate terminal at the visit time is not found, transmitting an electronic cancellation to the visitor via a telecommunications network;
(e) and if the visit is not cancelled, conducting a video visit between the booked inmate terminal and a visitor computing device comprising a web browser via said web browser at the visit time.

34. The process of claim 33 comprising creating a visitor account based on information received from the visitor via a web page.

35. The process of claim 33, wherein the visit is a confidential visit, said process comprising:
(a) reading a database record associated with the visitor from a visitor database, said record comprising a confidant variable designating that the visitor is entitled to confidential visits; and
(b) designating the room in the facility in which the inmate terminal is located as private to the inmate at the visit time in the scheduling database.

36. The process of claim 33, wherein the update of the inmate's location indicates that the inmate has been released; the process comprising transmitting an electronic cancellation to the visitor via a telecommunications network.

37. The process of claim 33, wherein the visitation rules variable is selected from the group consisting of: a general population rule, a protective custody population rule, an administrative segregation population rule, a disciplinary segregation population rule, a medical segregation population rule, a mental segregation population rule, a housing unit rule, and a facility rule.

38. The process of claim 33, comprising:
(a) receiving an additional request for an additional visitor to participate in the visit in machine-readable format, said additional request comprising an additional identifier of the additional visitor; and
(b) sending an electronic invitation to the additional visitor via a telecommunications network, said invitation comprising the visit time.

39. The process of claim 33 comprising:
(a) reading a database record associated with the visitor from a visitor database, said record comprising a confidant variable designating that the visitor is entitled to confidential visits; and
(b) designating the visit a confidential visit in the scheduling database.

40. The process of claim 33, wherein the visit algorithm applies at least one visiting hour rule selected from the group consisting of: a general population rule, a protective custody population rule, an administrative segregation population rule, a disciplinary segregation population rule, a medical segregation population rule, a mental segregation population rule, a housing unit rule, and a facility rule.

41. An automated process for scheduling a visit between a visitor and a resident of a detention facility, said process comprising:
(a) receiving a visit request in machine-readable format identifying an inmate residing in the facility and requesting a visit type selected from the group consisting of: an offsite video visit, and onsite video visit, and a contact visit;
(b) performing a fully automated scheduling process comprising:
(i) reading an inmate record from an inmate database, the inmate record comprising a visitation rules variable;
(ii) computing with a visit algorithm available times as a function of the value of the visitation rules variable;
(iii) reading available times from a scheduling database for a venue selected from the group consisting of: an inmate videoconference terminal and a contact room;
(iv) assigning a visit time that coincides with an available time from the scheduling database and the available times as a function of the value of the visitation rules variable;
(v) designating the venue as booked at the visit time in the scheduling database; and
(vi) if the visit type is an onsite video visit, designating an onsite visitor videoconference terminal as booked in a scheduling database;
(c) receiving an update of the inmate's location in machine-readable format from a jail management system;
(d) if the update indicates that the inmate has been moved to a new location within the facility, performing a fully automated rescheduling process comprising:
(i) searching for an available venue at the new location at the visit time in a scheduling database;
(ii) if an available venue at the new location at the visit time is found, designating the available venue at the new location as booked at the visit time; or
(iii) if an available venue at the visit time is not found, transmitting an electronic cancellation to the visitor via a telecommunications network;
(e) and if the visit is not cancelled, conducting a video visit between the booked inmate terminal and a visitor computing device comprising a web browser via said web browser at the visit time.

42. The process of claim 41 comprising creating a visitor account based on information received from the visitor via a web page.

43. The process of claim 41, wherein the visit is a confidential visit and wherein the venue is an inmate videoconference terminal, said process comprising:
(a) reading a database record associated with the visitor from a visitor database, said record comprising a confidant variable designating that the visitor is entitled to confidential visits; and
(b) if the venue is an inmate videoconference terminal, designating the room in the facility in which the inmate terminal is located as private to the inmate at the visit time in the scheduling database.

44. The process of claim 41, wherein the update of the inmate's location indicates that the inmate has been released; the process comprising transmitting an electronic cancellation to the visitor via a telecommunications network.

45. The process of claim 41, wherein the visitation rules variable is selected from the group consisting of: a general population rule, a protective custody population rule, an administrative segregation population rule, a disciplinary segregation population rule, a medical segregation population rule, a mental segregation population rule, a housing unit rule, and a facility rule.

46. The process of claim 41, comprising:
(a) receiving an additional request for an additional visitor to participate in the visit in machine-readable format, said additional request comprising an additional identifier of the additional visitor; and
(b) sending an electronic invitation to the additional visitor via a telecommunications network, said invitation comprising the visit time.

47. The process of claim 41 comprising:
(a) reading a database record associated with the visitor from a visitor database, said record comprising a confidant variable designating that the visitor is entitled to confidential visits; and
(b) designating the visit a confidential visit in the scheduling database.

48. The process of claim 41, wherein the visit algorithm applies at least one visiting hour rule selected from the group consisting of: a general population rule, a protective custody population rule, an administrative segregation population rule, a disciplinary segregation population rule, a medical segregation population rule, a mental segregation population rule, a housing unit rule, and a facility rule.

49. The process of claim 41, wherein the scheduling database comprises records indicating the availability of one or more inmate videoconference terminals and comprises records indicating the availability of one or more contact rooms.

50. The process of claim 41, wherein the venue is a contact room, wherein the update indicates that the inmate has been moved to a new location, comprising:
(a) searching in a scheduling database for the new location to find a contact room co-located at the inmate's new location at the visit time; and
(b) if an available contact room is found, transmitting a rescheduling request with the new location to the visitor via a telecommunications network.

51. The process of claim 41, wherein the inmate videoconference terminal is located in a terminal room in the facility, comprising:
(a) reading a database record associated with the visitor from a visitor database, said record comprising a confidant variable designating that the visitor is entitled to confidential visits;
(b) designating the visit a confidential visit in the scheduling database; and
(c) designating the terminal room in the facility as private to the inmate at the visit time in the scheduling database.
